(19) United States
(12) Patent Application Publication
(10) Pub. No.: US 2005/0268011 A1
(43) Pub. Date: Dec. 1, 2005

(54) Method, protocol and system for bidirectional communication in a communication system

(76) Inventors: Andreas Isenmann, Haslach i. K. (DE); Thomas Deck, Wolfach (DE); Josef Fehrenbach, Haslach i. K. (DE)

Correspondence Address: FAY KAPLUN & MARCIN, LLP, 15O BROADWAY, SUITE 702, NEW YORK, NY, 10038, US

(21) Appl. No.: 11/103,171

(22) Filed: Apr. 11, 2005

Related U.S. Application Data
(60) Provisional application No. 60/562,914, filed on Apr. 15, 2004.

(51) Int. Cl. G06F 13/00

(52) U.S. Cl. 710/110

(57) ABSTRACT

Described is a method for data communication in a communication system. The system includes a plurality of communication participants, each participant having a subsystem responsible for communication. A communication participant acts as master of the communication system, the subsystem of the master being operated continuously. The other communication participants act as communication slaves in the communication system. The subsystems of the communication slaves are de-energized, when no communication takes place. Furthermore, a protocol for controlling a bidirectional communication is provided. Establishment of the communication results from a special initial packet, which is transmitted by a communication slave to a communication master. The initial packet is acknowledged by the master with a confirmation packet. This confirmation packet comprises information, whether subsequent communication is required. Moreover, a communication system is provided, comprising a plurality of communication participants each having a respective subsystem responsible for the communication. At least one communication participant is adapted to act as master in the communication system, having a continuously operating subsystem. The other communication participants are adapted to act as communication slaves in the communication system, having subsystems, which are de-energized, when no communication takes place, whereby the communication participants are sensors.

### PRIORITY CLAIM

This application claims the benefit of U.S. Provisional Patent Application Ser. No. 60/562, 914 filed on Apr. 15, 2004 which application is expressly incorporated herein, in its entirety, by reference.

### TECHNICAL FIELD OF THE INVENTION

The present invention relates to a method for bidirectional communication in a communication system, a protocol for controlling the bidirectional communication, and a communication system.

### BACKGROUND OF THE INVENTION

Communication systems for carrying out data communication can either be adapted to provide for unidirectional or bidirectional communication. To enable for bidirectional communication, all components participating in the communication always have to be ready for receiving a communication packet. This permanent state of being ready to receive data, however, consumes a lot of energy.

Therefore, according to prior art, it is only provided for unidirectional communication in most communication systems. In case there is not sufficient energy available to operate all subsystems of the communication system, usually these subsystems are de-energized for the times, in which they are not needed. Often, in particular these subsystems, which are responsible for data communication, are affected by this energy saving measure.

Thus, for example the communication components of a sensor are only activated in case the sensor has to communicate a new measurement reading. This is disadvantageous, because it leads to a unidirectional communication, according to which only the sensor can carry out communication with external components. During the time, in which the sensor does not communicate, the subsystem responsible for communication is deactivated. Therefore, the sensor neither is able to receive any communication packets during this period. This leads to constrictions in the communication potential of the system.

It would be desirable to provide bidirectional communication such that the components of the system are always able to receive and transmit data, although the components of the system are not all the time energized due to energy saving reasons.

### SUMMARY OF THE INVENTION

Implementations of the invention can include one or more of the following features.

According to an aspect of the invention, a method for data communication in a communication system is provided, comprising a plurality of communication participants, each participant having a subsystem responsible for communication, whereby a communication participant acts as communication master of the communication system, the subsystem of the communication master being operated continuously, whereby the other communication participants act as communication slaves in the communication system, the subsystems of the communication slaves being de-energized, when no communication takes place.

The inventive method can either be carried out for simple communication between two participating components as well as for more complex communications involving more than two participating components. Any of the participating components can act as communication master of the system. Further, the communication participants are connected to an external control unit, communicating with the communication master of the communication system.

According to an aspect of the invention, data communication is carried out based on packets.

Another aspect of the present invention is that the communication master has a queue for each slave for collecting communication packets, which are communicated to the communication slave during the next communication establishment. These communication packets can be either received from another communication participant or from the external control unit.

According to a further aspect of the invention, the communication participants are sensors. It is possible to employ any kind of sensor as sensors used for level detection, for switching or for pressure detection.

The communication is always initiated towards the communication master of the communication system by a communication slave of the communication system. Moreover, it is provided for the communication between communication master and communication slave of the communication system taking place bi-directionally.

According to one more aspect of the invention, the communication takes place wireless by means of radio transmission. However, it can also be carried out via a bus system.

The communication slave of the communication system initiating the communication keeps the communication open for a fixedly defaulted timeslot. The communication between communication master and communication slave of the communication system is controlled by a special communication protocol.

According to a further aspect, the communication between communication master and communication slave of the communication system is carried out by means of a communication protocol, comprising a special command to terminate the communication. The communication between communication master and communication slave is terminated, if the energy available in the communication slave is not sufficient for maintaining the communication.

According to an aspect of the present invention, a method for data communication in a communication system is provided, comprising a plurality of communication participants, each participant having a subsystem responsible for communication, whereby a communication participant acts as communication master of the communication system, the subsystem of the communication master being operated continuously, whereby the other communication participants act as communication slaves in the communication system, the subsystems of the communication slaves being de-energized, when no communication takes place, whereby the communication between communication master and communication slave of the communication system takes place bi-directionally, whereby the communication is always initiated towards the communication master by the communication slave of the communication system, and whereby the communication participants are sensors.

One more aspect of the invention provides a protocol for controlling a bidirectional communication, whereby:
establishment of the communication results from a special initial packet, which is transmitted by a communication slave to a communication master
the initial packet is acknowledged by the communication master with a confirmation packet
this confirmation packet comprises information, whether subsequent communication is required.

According to a further aspect, each communication packet being sent to a communication slave by the communication master comprises information concerning the remaining energy of the communication slave. Each communication packet being sent to a communication slave by the communication master, comprises information concerning the number of communication packets for the communication slave, which are present in the communication master.

Moreover, according to an aspect of the present invention, a protocol for controlling data communication between a plurality of communication participants is provided, whereby at least one participant acts as communication master of the system, having a subsystem responsible for communication, which is operated continuously, and the other participants act as communication slaves of the system, having subsystems responsible for communication, which are de-energized, when no data communication takes place, according to which:
a communication participant acting as communication slave activates its subsystem responsible for communication
this communication participant communicates towards the communication master and keeps its subsystem responsible for communication active for the duration of the initial communication
the communication master confirms the receipt and responds by means of a response packet, containing information whether bidirectional connection is required for data communication, being possible at this point of time, whereby the communication master transmits communication packets to the client and vice versa.

Moreover, the bidirectional communication is terminated, when the communication master no longer transmits communication packets to the communication slave. The bidirectional communication is terminated according to another aspect of the invention, when the energy available from client which is required for maintaining data communication, is not sufficient. For saving energy, the slave deactivates its communication system, after communication is terminated.

According to an aspect of the present invention, a communication system comprising a plurality of communication participants, each having a respective subsystem responsible for the communication, whereby at least one communication participant is adapted to act as communication master in the communication system, having a continuously operating subsystem, whereby the other communication participants are adapted to act as communication slaves in the communication system, having subsystems which are de-energized, when no communication takes place.

The communication system further comprises a control unit, which is adapted to communicate with the communication master of the communication participants. Moreover, the communication system is adapted for bidirectional communication between the communication participants. According to a further aspect, the communication participants of the communication system are connected to each other via a bus system. However, the communication participants can also be equipped for wireless data transmission, for example by means of respective infrared interfaces.

### BRIEF DESCRIPTION OF THE DRAWINGS

FIG. 1 is a schematic diagram of an arrangement of a communication system implementing the inventive method.

FIG. 2 is a flowchart of a communication.

### DETAILED DESCRIPTION OF EXEMPLARY EMBODYMENTS OF THE PRESENT INVENTION

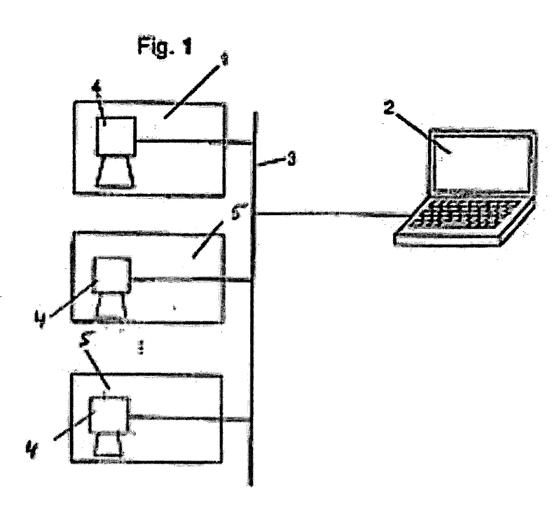

According to FIG. 1, a plurality of components is shown, which participate in the communication. These components are sensors 4, which are connected via a bus system 3 to each other. The bus system 3 is also connected to an external control unit 2, which is a PC here. The control unit 2 can also participate in data communication, as it transmits data to the sensor, e.g. data for configuration or setting of the sensor, and also receives data from the sensors, as for example the measured values.

At least one of the plurality of components 4 adopts the role of the communication server or master 1 of the communication system, respectively. This communication server or master 1 comprises a communication subsystem, i.e. a subsystem responsible for the communication, which has to be operated continuously without any interruptions or breaks for energy saving reasons or other reasons.

All other components participating in the communication act as slaves 5 or clients with respect to the master 1 in the communication system. They do not have to operate their communication subsystems continuously. To start a communication, always one of the communication clients or slaves 5 activates its subsystem. It communicates towards the communication server or master 1 of the system and maintains the communication for a predetermined timeslot. During this period, the communication server or master 1 is able to communicate also towards the communication client or slave 5.

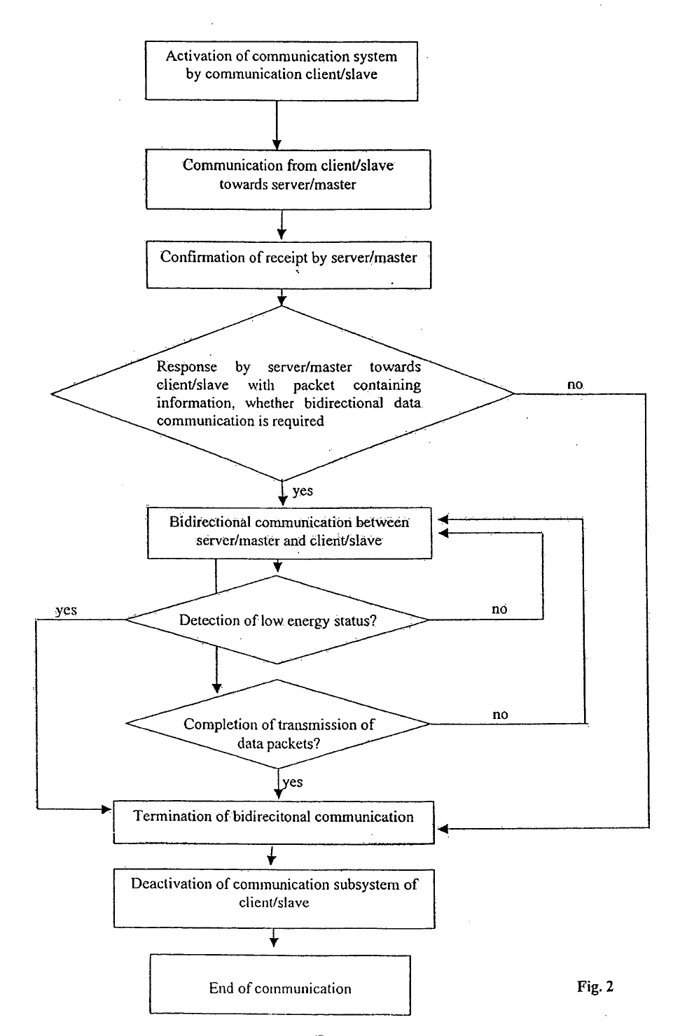

As can be seen from the flowchart shown in FIG. 2, the first step of the communication is that a communication client or slave 5 activates its subsystem responsible for communication.

Next, this communication client or slave 5 communicates towards the communication server or master 1 of the communication system and keeps its subsystem active during this initial communication. The communication server or master 1 confirms receipt and responds with a response packet, containing information, whether bidirectional connection is required for data communication.

If bidirectional connection is required, bidirectional communication is possible at this point of time. The communication server or master 1 transmits communication packets to the communication client or slave 5 and vice versa.

The bidirectional communication is terminated, if no longer communication packets have to be sent by the communication server or master 1 to the communication client or slave 5, or in case there is not sufficient energy left for maintaining the communication. In the next step, the communication client or slave 5 deactivates its communication system. Communication is terminated.

Other embodiments are in the scope of the following claims.

1-27. (canceled)

28. A method for data communication in a communication system, the system including a plurality of communication participants, each communication participant having a subsystem responsible for communication, the method comprising:
acting, by a communication participant, as a communication master of the communication system;
operating continuously the subsystem of the communication master;
acting, by other communication participants, as communication slaves in the communication system; and
when no communication takes place, de-energizing the subsystems of the communications slaves.

29. The method according to claim 28, wherein the communication participants are connected to an external control unit, the method further comprising the step of:
communicating, by the external control unit, with the communication master of the communication system.

30. The method according to claim 28, wherein the communication participants are sensors.

31. The method according to claim 28, further comprising:
initiating the communication always towards the communication master of the communication system by the communication slave of the communication system.

32. The method according to claim 28, further comprising:
communicating bi-directionally between the communication master and the communication slave of the communication system.

33. The method according to claim 28, further comprising:
communicating wirelessly by means of radio transmission.

34. The method according to claim 28, further comprising:
communicating via a bus system.

35. The method according to claim 28, further comprising:
communicating between two communication participants.

36. The method according to claim 28, wherein when the communication slave of the communication system initiates the communication, the method further comprising the step of:
maintaining the communication open for a fixedly defaulted timeslot.

37. The method according to claim 28, further comprising:
communicating, between the communication master and the communication slave of the communication system, by a special communication protocol.

38. The method according to claim 28, further comprising:
communicating, between the communication master and the communication slave of the communication system, by means of a communication protocol; and
terminating the communication using a special command.

39. The method according to claim 28, further comprising:
terminating the communication between the communication master and the communication slave when an energy available in the communication slave is not sufficient for maintaining the communication.

40. The method according to claim 28, wherein the data communication is based on packets.

41. The method according to claim 28, further comprising:
collecting, by the communication master, communication packets in a queue for each communication slave; and
communicating, by the communication master, the packets in the queue to the communication slave.

42. A method for data communication in a communication system, the system including a plurality of communication participants, each participant having a subsystem responsible for communication, the method comprising:
acting, by a communication participant, as a communication master of the communication system;
operating continuously the subsystem of the communication master;
acting, by the other communication participants, as communication slaves;
when no communication takes place, de-energizing the communication slaves;
initiating the communication by the communication slave towards the communication master; and
communicating bi-directionally between the communication master and the communication slave of the communication system,
wherein the communication participants are sensors.

43. A protocol for controlling a bidirectional communication, comprising:
establishing the communication with a special initial packet transmitted by a communication slave to a communication master; and
acknowledging the initial packet by the communication master with a confirmation packet,
wherein the confirmation packet includes information indicative of whether subsequent communication is required.

44. The protocol according to claim 43, wherein when subsequent communication is required, the method further comprising:
transmitting communication packets to the communication slave by the communication master, each of the communication packets including information concerning a remaining energy of the communication slave.

45. The protocol according to claim 43, wherein when subsequent communication is required, the method further comprising:
transmitting communication packets to the communication slave by the communication master, each of the communication packets including information concerning a number of communication packets for the communication slave which are present in the communication master.

46. A protocol for controlling data communication between a plurality of communication participants, comprising:
acting, by at least one participant, as a communication master, the communication master having a subsystem responsible for communication;
operating continuously the subsystem of the communication master;
acting, by other participants, as communication slaves, each of the communications slaves having a subsystem responsible for communication;
when no data communication takes place, de-energizing the subsystems of the communication slaves;
activating, by the communication slave, the subsystem responsible for communication;
when the communication slave communicates towards the communication master, maintaining the subsystem responsible for communication active for a duration of an initial communication;
confirming, by the communication master, receipt of the initial communication;
responding, by the communication master, by means of a response packet, the response packet containing information whether a bidirectional connection is required for data communication; and
when the bidirectional connection is required, communicating communication packets between the communication master the communication slave.

47. The protocol according to claim 46, further comprising:
terminating the bidirectional connection when the communication master no longer transmits communication packets to the communication slave.

48. The protocol according to claim 46, further comprising:
terminating the bidirectional connection when an energy available from the communication slave which is required for maintaining data communication is not sufficient.

49. The protocol according to claim 46, further comprising:
deactivating, by the communication slave, the subsystem for communication after the data communication is terminated.

50. A communication system, comprising:
a plurality of communication participants, each communication participant having a respective subsystem responsible for communication, at least one communication participant adapted to act as a communication master in the communication system, the communication master having a continuously operating subsystem, other communication participants are adapted to act as communication slaves in the communication system, each of the communication slaves having a subsystem which is de-energized when no communication takes place,
wherein the communication participants are sensors.

51. The communication system according to claim 50, further comprising:
a control unit adapted to communicate with the communication master of the communication participants.

52. The communication system according to claim 50, wherein the communication participants are adapted for bidirectional communication.

53. The communication system according to claim 50, further comprising:
a bus system connecting the communication participants.

54. The communication system according to claim 50, wherein each of the communication participants is equipped for wireless data transmission.
